(19) United States
(12) Patent Application Publication
(10) Pub. No.: US 2020/0242687 A1
(43) Pub. Date: Jul. 30, 2020

(54) OPTIMIZED DATA MODEL FOR STEP-DOWN LEASING ARRANGEMENT

(71) Applicant: Craig H. LUSSI, Gibson Island, MD (US)

(72) Inventor: Craig H. LUSSI, Gibson Island, MD (US)

(21) Appl. No.: 16/753,651

(22) PCT Filed: Oct. 3, 2018
(86) PCT No.: PCT/US2018/054239

§ 371 Date: Apr. 3, 2020

Related U.S. Application Data
(60) Provisional application No. 62/568,122, filed on Oct. 4, 2017.

(51) Int. Cl. G06Q 30/06; G06Q 30/02; G06F 16/9035

(52) U.S. Cl. CPC G06Q 30/0645; G06Q 50/16; G06F 16/9035; G06Q 30/0207

(57) ABSTRACT

Embodiments are directed to an optimized data model for determining values for a step-down leasing arrangement. In an embodiment, a connection manager implemented at a server device receives a base rent, an original square footage, a rent escalator, and an original term. A step-down core, implemented on the server device, may determine a step-down term and a step-down space reduction factor. The step-down core may compute an original annual accrual cost based on the base rent, the original square footage, the rent escalator, and the original term. The step-down core may calculate a step-down annual obligation based on a remaining accrual obligation over an initial term and a new obligation over the step-down term. The step-down core may then identify an annual obligation reduction by subtracting the step-down annual obligation from the original annual accrual cost. The annual obligation reduction may represent cost savings achieved by the step-down leasing arrangement.

### BACKGROUND

Typical leasing structures specify a fixed amount of space for a fixed term. This structure requires lessees to forecast future needs prior to entering into a lease, or alternatively negotiating a reduced amount of space at some point during the lease term, which normally carry higher rates and/or penalties. These leasing structures are particularly problematic for long-term commercial leases, where the typical lease term may be 10 or more years. Thus, tenants must commit to a fixed amount of space in the hope that this space will meet their needs 10 years from lease execution, or negotiate future expansion or reduction rights that may (a) lack any immediate economic benefit and (b) require an extra cost.

Additionally, the Financial Accounting Standards Board (FASB) issues generally accepted accounting standards for leases that are required to be followed by many corporations, nonprofit organizations, and similar organizations. These standards advise that rental expenses be recognized on a straight-line basis. As rent commonly increases over the period of a lease, a fixed term, fixed space lease may require recognition of significantly higher expenses than actual payments made to the lessor during the first half of the term of the lease.

### SUMMARY

Disclosed herein are embodiments directed to an optimized data model for determining values for a step-down leasing arrangement. In an embodiment, a server device connected to a packet-switched network includes a connection manager, a step-down core, a query manager, and a reporting manager. The connection manager may receive, via the packet-switched network, a base rent, an original square footage, a rent escalator, and an original term. The connection manager may also receive a step-down term and a step-down space reduction factor, or these values may be determined by the step-down core in conjunction with the query manager, which may retrieve statistical data from a data repository coupled to the server device. The step-down core may then compute an original annual accrual cost based on the base rent, the original square footage, the rent escalator, and the original term. In an embodiment, the original annual accrual cost may be computed on a straight-line basis over the duration of the original term.

In an embodiment, the step-down core of the server device may compute a remaining accrual obligation based on the original annual accrual cost and an initial term. The initial term may represent the difference between the original term and the step-down term. The step-down core may determine a new obligation for the step-down term based on the base rent, the rent escalator, the step-down term, and a reduced square footage. The reduced square footage may be calculated from the original square footage and the step-down space reduction factor. The step-down core may then calculate a step-down annual obligation based on the remaining accrual obligation, the new obligation, and the original term.

In an embodiment, the step-down core of the server device may identify an annual obligation reduction by subtracting the step-down annual obligation from the original annual accrual cost. The reporting manager of the server device may then generate a step-down lease based on the step-down annual obligation when the annual obligation reduction exceeds a reduction threshold. The annual obligation reduction may represent cost savings achieved by the step-down lease.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings are incorporated herein and form a part of the specification.

FIG. 1 is a diagram illustrating a leasing arrangement between a lessor and a lessee, according to some embodiments.

FIG. 2A is a diagram illustrating a data model for determining values for a step-down leasing arrangement, according to some embodiments.

FIG. 2B is a diagram illustrating an example application of a data model for determining values for a step-down leasing arrangement, according to some embodiments.

FIG. 3 is an example system for employing a data model for determining values for a step-down leasing arrangement, according to some embodiments.

FIG. 4 is a flowchart illustrating an example process for employing a data model for determining values for a step-down leasing arrangement, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, directed to generating lease structures, referred to herein as step-down leases, for optimizing future square footage needs vs. straight-line operating expenses for commercial leases.

The last several decades have brought about advances in technology that have reduced space requirements for office, retail, residential, and ground leases. These technological advances have allowed many aspects of the business process to be performed electronically and/or remotely, requiring smaller lease space, while driving space planning efficiencies, building efficiencies, furniture and fixture efficiencies, and expected work schedules. A step-down lease, as discussed in detail below, enables any office, retail, residential and/or ground lease tenant, such as corporations, nonprofit organizations, law firms, and individuals, to benefit immediately and during the entire term of the lease from the reduced lease space requirements that have continued to decrease in recent years.

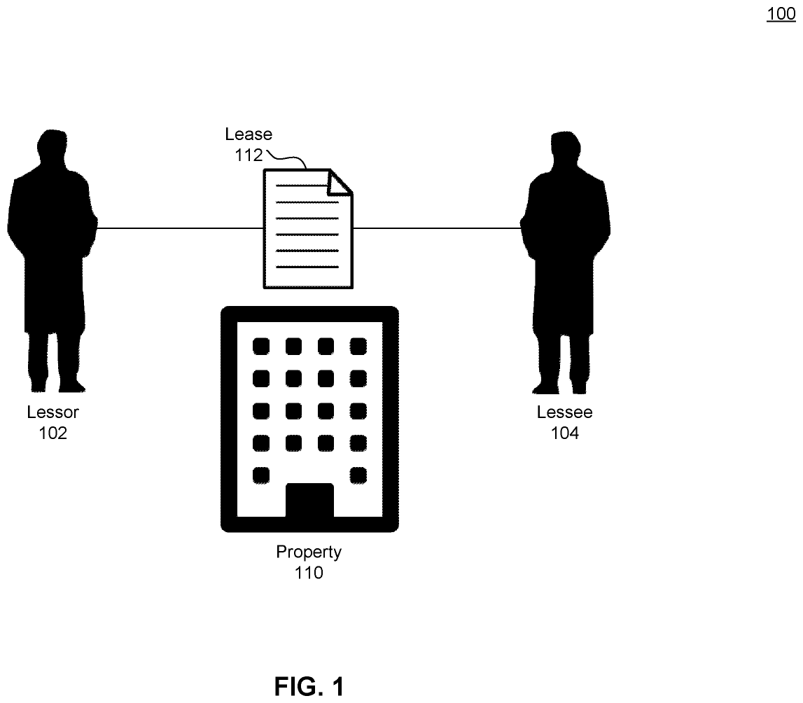

FIG. 1 is a diagram 100 illustrating a generic leasing arrangement between a lessor and a lessee, according to some embodiments. Diagram 100 provides a lease 112 between lessor 102 and lessee 104 for space within property 110. In some embodiments, property 110 may provide office, retail, residential, and/or ground lease space to tenants. Lessor 102 and lessee 104 may each be an individual, nonprofit organization, corporation, or any group thereof.

Prior to step-down leases, lessee 104 would typically need to determine current and future space needs at lease execution, which would be fixed over a predetermined term of years (e.g., 10 years). While lessee 104 may attempt to negotiate space expansion and/or reduction rights, these rights may be costly to lessee 104. In particular, reduction rights have historically been difficult and expensive to negotiate. Although these expansion and reduction rights may benefit lessee 104 in the future once exercised (if ever), these rights provide no immediate annual economic benefit with respect to the financial statements of corporations and nonprofit organizations (and any tenant who accounts for operating leases on a straight-line basis). This result occurs because future reduction rights do not affect the expected annual rental expenses, and as such, the reported rental expense does not change until the future rights are exercised. Similarly, fixed term, fixed spaces leases provide little recruiting benefit to law firms whose younger members/partners often see the long-term leases for a fixed amount of office space as a burden passed down from the more senior members/partners.

By way of mathematical example and not restriction, straight-line accounting for office, retail, residential and or ground lease rent is structured so that the total liability under an operating lease is charged as an expense on an even annual basis over the term of the lease. To calculate straight-line annual rent, the aggregate cost of all annual lease payments are divided by the total number of years of lease term. The resulting annual amount is the straight-line annual lease expense (also referred to herein as the annual accrual cost). This calculation typically includes all discounts and concessions from the contracted rent, as well as extra charges that may reasonably be expected to be charged over the term of the lease.

The calculation of straight-line rent may result in an annual rent expense that is different from the actual annual cash amount billed by the lessor (e.g., landlord). This difference occurs because the lessor commonly builds into the lease a rent escalator, which specifies an increase in annual rent. Because of this, the straight-line annual accrual cost of the lessee's financial statements is higher than the actual cash payments during the first half of the total years of the lease term, and lower than the actual cash payments during the second half of the total years of the lease term.

This difference between the annual accrual cost and the cash payments during the first half of the lease term, where the annual accrual cost reported on the lessee's financial statements are greater than the cash payments, is paid into an accrued liability account. During the second half of the total years of the lease term, where the cash payments are greater than the annual accrual cost reported on the lessee's financial statements, the payments that were paid into the accrued liability account are reversed and paid to the lessor. By the end of the lease term, the difference is balanced and the accrued liability account contains a zero balance.

By way of example, lessor 102 and lessee 104 may enter into a 10-year lease in which the agreed upon annual cash rent is $500,000 for the first year, with a rent escalator of 5% per year for the remainder of the 10-year lease term. In this case, the following chart illustrates the annual rent (e.g., cash payment) from lessee 104 to lessor 102:

| Year | Rent |
|---|---|
| 1 | $500,000 |
| 2 | $525,000 |
| 3 | $551,250 |
| 4 | $578,813 |
| 5 | $607,754 |
| 6 | $638,142 |
| 7 | $670,754 |
| 8 | $703,552 |
| 9 | $738,730 |
| 10 | $775,664 |
| Total | $6,288,957 |

On a straight-line basis, the annual accrual cost may be computed by dividing the total rent by the duration. Thus, in the example above, the straight-line annual accrual cost is $628,896 per year ($6,288,957/10 years). In the first year of the lease, lessee 104 would record an operating lease expense of $628,896 (debit), a cash reduction of $500,000 (credit), and an accrued liability of $128,896 (credit).

In contrast to such traditional fixed term and fixed space lease arrangements, a step-down lease enables lessees, who account for operating leases on a straight-line basis, to realize the economic benefit of continuing reductions in space requirements on their financial statements without the expense of redesigning and/or rebuilding lease spaces at a reduced size. In an embodiment, a step-down lease may automatically reduce the space leased during the term of the lease, and the lessee has the exclusive option to decline this reduction. That is, the lessee must exercise its option in order to remain at the same amount of lease space. The automatic reduction creates a smaller cash liability for later years of the lease, leading to a smaller straight-line annual accrual cost over the duration of the entire lease. And since the space reduction is automatic, the option to decline the reduction provides built-in renegotiation leverage for the lessee. In the event the lessee elects not to reduce the amount of lease space when the reduction is scheduled to occur, the lessee may renegotiate the step-down lease to extend the duration at the current amount of space, while retaining an automatic space reduction in the future of the extended step-down lease, and thus maintaining the favorable straight-line accounting treatment on the tenant's financial statements.

Continuing with a similar example as described above, lessor 102 and lessee 104 may enter into a 10-year step-down lease in which the agreed upon annual cash rent is $500,000 for the first year, with a rent escalator of 5% per year, and a 50% space reduction commencing in year 6. In this case, the following chart illustrates the annual rent (e.g., cash payment) from lessee 104 to lessor 102:

| Year | Rent |
|---|---|
| 1 | $500,000 |
| 2 | $525,000 |
| 3 | $551,250 |
| 4 | $578,813 |
| 5 | $607,754 |
| 6 | $319,071 |
| 7 | $335,025 |
| 8 | $351,776 |
| 9 | $369,356 |
| 10 | $387,834 |
| Total | $4,525,879 |

In the example above, the straight-line annual accrual cost is $452,588 per year ($4,525,879/10 years). Although the cash payments and amount of lease space for the first five years are unchanged from a standard lease, the step-down lease provides an immediate 28% reduction in the straight-line annual accrual cost. Lessee 104 further retains flexibility to remain at the larger space size (if needed) by declining the automatic space reduction at year 6.

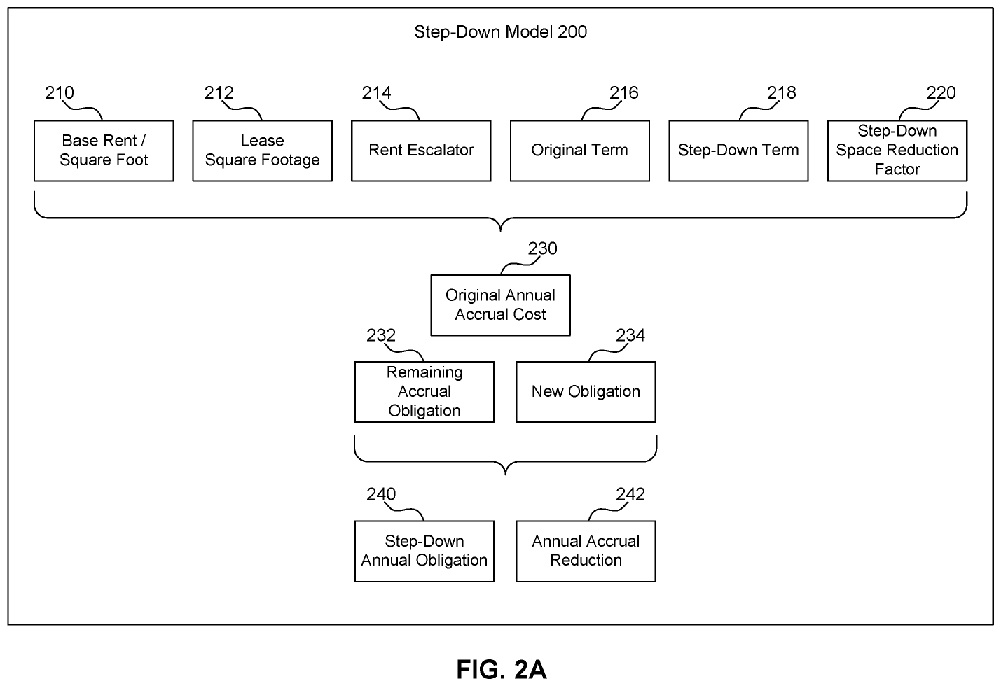

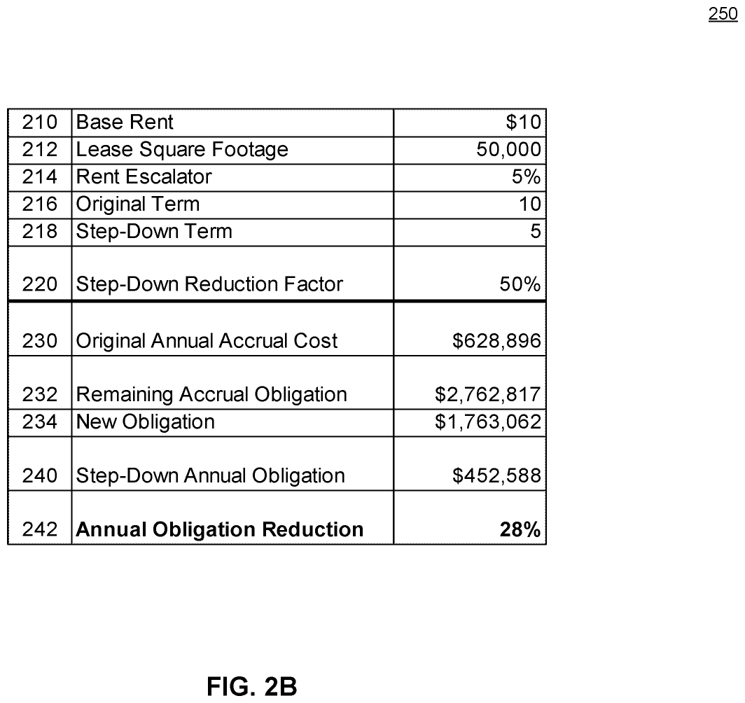

In some embodiments, a step-down lease may be developed and evaluated by employing a step-down data model. FIG. 2A is a diagram illustrating a data model 200 for determining values for a step-down leasing arrangement, according to some embodiments. Step-down model 200 receives several inputs, including and without limitation, base rent 210, lease square footage 212, rent escalator 214, original term 216, step-down term 218, and step-down space reduction factor 220. In an embodiment, lease square footage 212 denotes the initial amount of lease space. Although lease square footage 212 may commonly be denoted in square feet, lease square footage 212 may represent any agreed upon measurement of area. In an embodiment, base rent 210 denotes the rent per square foot (or other unit of measurement as appropriate) for a particular term, such as per year. Thus, base rent 210 multiplied by lease square footage 212 may denote the cash rental expense for the first year of the step-down lease. In an embodiment, base rent 210 may be provided as total rental cost of lease square footage 212 for a particular term, which may then be normalized to represent rent per square foot.

Rent escalator 214 may represent an annual rent increase, which may take the form of a percentage, fixed value, or other formulaic increase. In an embodiment, original term 216 represents the total term of the lease, for example 10 years. Step-down term 218 may represent a portion of original term 216 for which the lease space reduction is in effect, and step-down space reduction factor 220 may represent the amount of space reduction from lease square footage 212, which may take the form of a percentage, fixed value, or other formulaic reduction.

In an embodiment, one or more of inputs 210-220 are provided by the lessor and/or lessee involved in the step-down lease. Multiple values for each input may be provided in order to evaluate the benefits of different options. Rather than be provided to data model 200, step-down term 218 and/or step-down space reduction factor 220 may also be determined by data model 200 considering factors such as, without limitation, a personnel count of the lessee, an estimated personnel growth rate of the lessee, and an industry associated with the lessee. These factors may be provided by the lessor and/or lessee to data model 200 or identified based on other data available to data model 200. Step-down term 218 and step-down space reduction factor 220 may then be estimated based on one or more of these factors. In an embodiment, the industry associated with the lessee may be correlated to historical lessee space usage for that industry, for example using statistical data accessible by data model 200, which may in turn be used to estimate step-down term 218 and step-down space reduction factor 220.

With inputs 210-220 established, in an embodiment, data model 200 may be employed to compute original annual accrual cost 230, remaining accrual obligation 232, and new obligation 234. Original annual accrual cost 230 may represent the straight-line annual accrual cost of the lessee over original term 216 without accounting for any space reduction. In other words, original annual accrual cost 230 may represent the annual accrual cost of the lessee in a traditional fixed term, fixed space lease. In an embodiment, original annual accrual cost 230 may be computed as follows:

$$\frac{{Σ}_{1}^{T} \{ ( base rent \times lease sq ft ) \times {( 1 + rent escalator )}^{year - 1} \}}{T} \qquad [ 1 ]$$

In the above, T represents original term 216. In an embodiment, original annual accrual cost 230 may be reduced based on any discounts and/or concessions received from the lessor.

Remaining accrual obligation 232 may represent the actual rental expense for the initial term of the lease, prior to the lease space reduction (e.g., the portion of original term 216 at the full lease square footage 212). In an embodiment, remaining accrual obligation 232 may be computed as follows:

Σ₁^{T-S}{(base rent×lease sq ft)×(1+rent escalator)^{year-1}} [2]

In the above, T represents original term 216 and S represents step-down term 218.

New obligation 234 may represent the actual rental expense for the later term of the lease at the reduced amount of lease space (e.g., rental expense for step-down term 218). Because step-down term 218 takes effect during the step-down lease, the new obligation 234 may take into account rent escalator 214 and the number of years prior to step-down term 218. In an embodiment, new obligation 234 may be computed as follows:

Σ_{(T-S)+1}^{T}{(base rent×lease sq ft×R)×(1+rent escalator)^{year-1}} [3]

In the above, T represents original term 216, S represents step-down term 218, and R represents step-down space reduction factor 220.

Step-down annual obligation 240 and annual obligation reduction 242 may be determined from the above, which may be used by the lessor and lessee to develop and evaluate terms for an acceptable step-down lease. Step-down annual obligation 240 may represent the straight-line annual accrual cost for a step-down lease specifying terms in line with inputs 210-220. Annual obligation reduction 242 may then represent the cost savings between original annual accrual cost 230 and step-down annual obligation 240, or in other words the straight-line cost benefits of the step-down lease compared to a traditional fixed term, fixed space lease. In an embodiment, step-down annual obligation 240 may be calculated as follows:

$$\frac{remaining accrual obligation + new obligation}{T} \qquad [ 4 ]$$

In the above, T represents original term 216.

Finally, in an embodiment, the annual obligation reduction 242 may be identified as follows:

$$\frac{original annual accrual cost - step \text{-} down annual obligation}{original annual accrual cost} \qquad [ 5 ]$$

FIG. 2B illustrates an example application of data model 200, according to some embodiments. In the example of FIG. 2B, which follows the examples discussed previously, data model 200 receives inputs including a base rent of $10 per square foot, a lease square footage of 50,000 square feet, a rent escalator of 5%, an original term of 10 years, a step-down term of 5 years, and a step-down space reduction factor of 50%, which takes effect at year 6 of the step-down lease.

The original annual accrual cost of $628,896 may then be computed according to Equation [1], the remaining accrual obligation is $2,762,817 according to Equation [2], and the new obligation is $1,763,062 according to Equation [3]. Using Equation [4], the step-down annual obligation is $452,588, resulting in a 28% annual obligation reduction according to Equation [5].

In this manner, data model 200 enables lessors and lessees to determine appropriate terms for a step-down lease. Inputs 210-220 may be varied, and data model 200 automatically adapts to determine resulting step-down annual obligation 240 and annual obligation reduction 242. A step-down lease based on these values may then be generated when the terms are acceptable to both the lessor and the lessee. In an embodiment, a reduction threshold may be set, either by the lessor/lessee or automatically by data model 200, which may trigger generation of the step down lease when annual obligation reduction 242 exceeds this threshold. The reduction threshold may represent an amount of reduction from original annual accrual cost 230. For example, the lessee may set the reduction threshold at 25%, which may then be compared to the resulting annual obligation reduction 242. In an embodiment, the reduction threshold may be determined based on expense requirements received from the lessee. In an embodiment, the lessor may additionally or alternatively set a reduction limit that represents a reduction value not to be exceeded by annual obligation reduction 242.

In an embodiment, the step-down lease allows enough time for initial construction-permanent financing (or refinancing) of an office, retail, and/or residential building supported by the larger lease space size (for example, most owners/developers/lenders require a minimum of five years at the larger amount of lease space). Additionally, the step-down lease may be implemented as a renegotiated lease extension clause inserted into an ongoing lease agreement without the positive straight-line accounting for the lessee negatively affecting the lessor's straight-line accounting. In an embodiment, the lessor is provided the exclusive right to terminate the step-down lease if the lessee does not exercise its option to remain at the original, larger lease size. Because the lessor has the right to terminate the lease at the time of automatic reduction of lease space, the lessor may separately account for the lease in two portions: (1) the lease term before the lessee's option period for which the straight-line calculation is known by the lessor; and (2) the period after lessee's option period, which is known only by the lessee and cannot not be straight-lined by the lessor until such time as the lessee selects or declines on lessee's option to remain the original, larger lease size.

In an embodiment, the step-down lease includes notice periods in which the lessee must inform the lessor that the option to remain at the larger lease size is being exercised. For example, the step-down lease may indicate at least twelve (12) months of notice must be given by the lessee to the lessor. In the event that the lessor terminates the lessee's lease upon automatic lease space reduction, the lessee's accounting treatment typically is not subjected to any negative impact because the lessee may simply enter into a new lease for a smaller lease space.

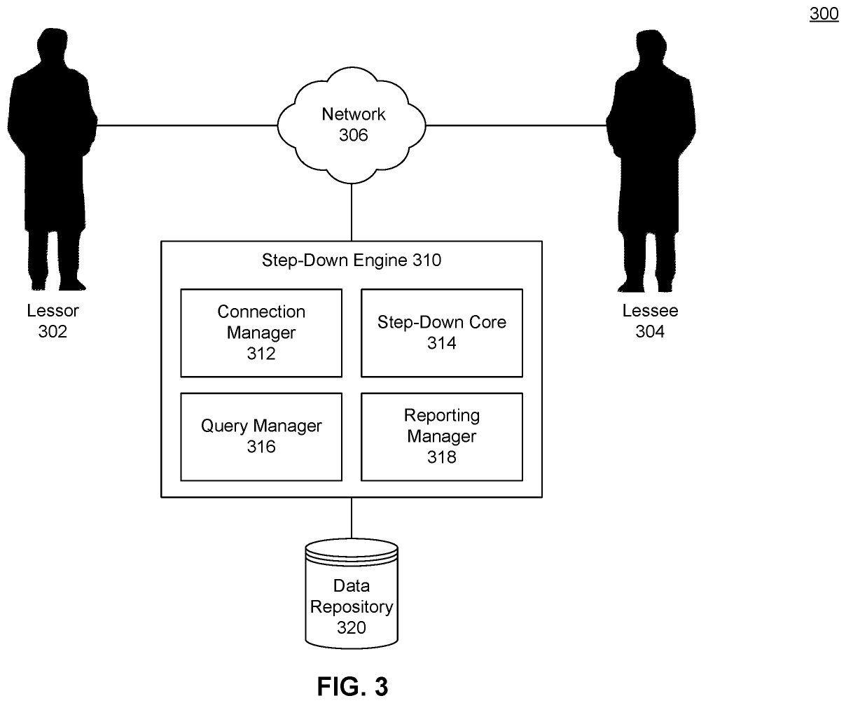

FIG. 3 is an example system 300 for employing a data model for determining values for a step-down leasing arrangement, according to some embodiments. In an embodiment, system 300 includes a lessor 302 and a lessee 304 connected to step-down engine 310 via network 306. Network 306 may be any type of computer or telecommunications network capable of communicating data, for example, a local area network, a wide-area network (e.g., the Internet), or any combination thereof. Lessor 302 and lessee 304 may each be an individual, organization, corporation, or any group thereof, and may be substantially similar to lessor 102 and lessee 104 of FIG. 1, respectively. In some embodiments, lessor 302 may represent a landlord and lessee 304 may represent a tenant, or in the case of a sublease, lessor 302 may represent a tenant and lessee 304 may represent a subtenant. According to an embodiment, step-down engine 310 may employ a step-down data model, such as step-down data model 200 of FIG. 2A, to facilitate a step-down lease between lessor 302 and lessee 304. In an embodiment, lessor 302 and lessee 304 may each operate any type of computing or electronic device that is capable of communicating with step-down engine 310 via network 306.

In an embodiment, step-down engine 310 includes connection manager 312, step-down core 314, query manager 316, and reporting manager 318. Connection manager 312 may communicate with lessor 302 and/or lessee 304 to obtain information, for example and without limitation, an initial lease square footage (or other unit of measure), a base rent per square foot (or other unit of measure), a rent escalator, a desired (original) lease term, a desired step-down term, and/or a desired step-down space reduction factor, as discussed above with respect to FIGS. 1, 2A, and 2B. In an embodiment, the step-down term and step-down space reduction factor may be automatically determined by step-down core 314. This automatic determination may be made with the aid of accessible statistical data, as discussed with respect to FIG. 2A, which may be stored in data repository 320 according to an embodiment. Data repository 320 may be managed by step-down engine 310 or by a separate third party. In an embodiment, query manager 316 may interact with data repository 320, relaying information to step-down core 314.

In an embodiment, step-down core 314 may perform operations in accordance with the step-down data model, such as the computations of Equations [1]-[5] discussed with respect to FIG. 2A. Step-down core 314 may provide results to reporting manager 318, such as a step-down annual obligation and annual obligation reduction based on the information obtained from lessor 302 and/or lessee 304. In an embodiment, reporting manager 318 may provide these results to lessor 302 and/or lessee 304 via network 306. In some embodiments, the results may be transmitted directly by reporting manager 318 or made available for access by lessor 302 and lessee 304, for example via a graphical user interface or application programming interface (API). In an embodiment, reporting manager 318 may also generate a step-down lease based on the step-down annual obligation when the annual accrual reduction exceeds a reduction threshold, as discussed in detail above with respect to FIG. 2.

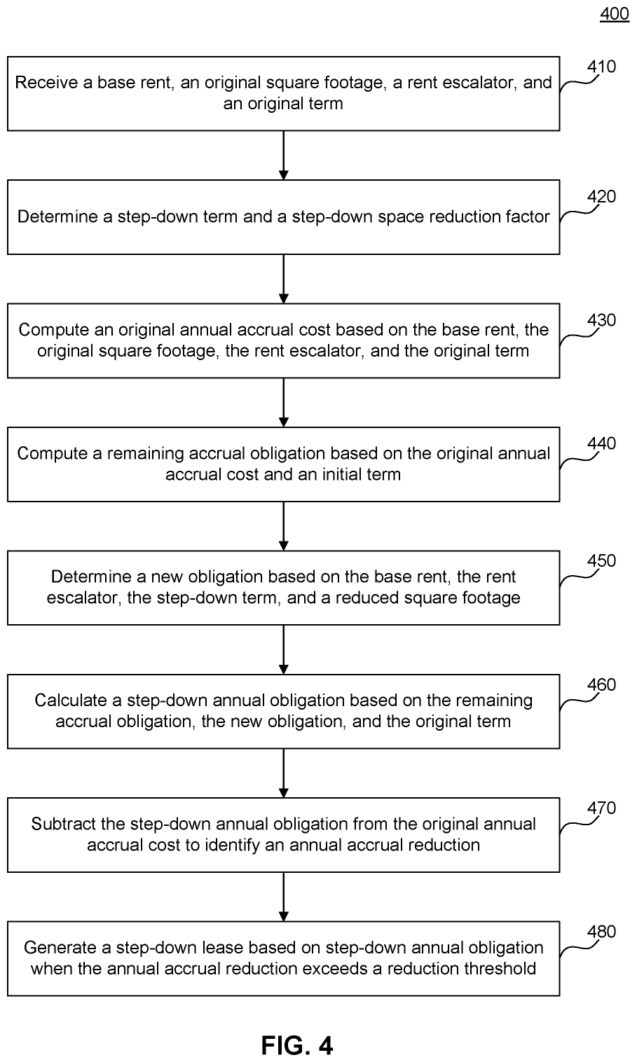

FIG. 4 is a flowchart illustrating an example process 400 for employing a data model for determining values for a step-down leasing arrangement, according to some embodiments. In an embodiment, the employed data model may be similar to data model 200 as discussed with respect to FIG. 2. In some embodiments, method 400 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

At 410, a base rent, an original square footage, a rent escalator, and an original term may be received. Original square footage may denote an initial amount of lease space for the step-down lease. Although the original square footage may commonly be denoted in square feet, the original square footage may represent any agreed upon measurement of area. The base rent may denote the rent per square foot (or other unit of measurement as appropriate) for a particular term, such as per year. In an embodiment, the base rent may be provided as total rental cost of the original square footage for a particular term, which may then be normalized to represent rent per square foot. The rent escalator may represent an annual rent increase, which may take the form of a percentage, fixed value, or other formulaic increase. The original term may represent the total term of the lease, such as 10 years. In an embodiment, the received data may be provided by a lessor and/or lessee involved in the step-down lease.

At 420, a step-down term and a step-down space reduction factor may be determined. The step-down term may represent a portion of the original term for which a lease space reduction is in effect, and the step-down space reduction factor may represent an amount of space reduction from the original square footage, which may take the form of a percentage, fixed value, or other formulaic reduction. In an embodiment, the step-down term and the step-down space reduction factor may be provided by the lessor and/or lessee.

Additionally or alternatively, in an embodiment, the step-down term and/or step-down space reduction factor may be determined automatically considering factors such as, without limitation, a personnel count of the lessee, and estimated personnel growth rate of the lessee, and an industry associated with the lessee. These factors may be provided by the lessor and/or lessee or identified based on other available and accessible data. The step-down term and the step-down space reduction factor may then be estimated based on one or more of these factors. In an embodiment, the industry associated with the lessee may be correlated to historical lessee space usage for that industry, for example using accessible statistical data, which may in turn be used to estimate the step-down term and the step-down space reduction factor.

At 430, an original annual accrual cost may be computed based on the base rent, the original square footage, the rent escalator, and the original term. The original annual accrual cost may represent the straight-line annual accrual cost of the lessee over the original term without accounting for any space reduction. In an embodiment, the original annual accrual cost may be computed using Equation [1] discussed with respect to FIG. 2A.

At 440, a remaining accrual obligation may be computed based on the original annual accrual cost and an initial term. The remaining accrual obligation may represent the actual rental expense for the initial term of the lease, prior to any lease space reduction (e.g., the portion of the original term at the full original square footage). In an embodiment, the original annual accrual cost may be computed using Equation [2] discussed with respect to FIG. 2A.

At 450, a new obligation may be determined based on the base rent, the rent escalator, the step-down term, and a reduced square footage. The new obligation may represent the actual rental expense for the later term of the step-down lease at the reduced amount of lease space (e.g., rental expense for the step-down term). Because the step-down term takes effect during the step-down lease, the new obligation may take into account the rent escalator and the number of years prior to the step-down term. In an embodiment, the new obligation may be determined according to Equation [3] discussed with respect to FIG. 2A.

At 460, a step-down annual obligation may be calculated based on the remaining accrual obligation, the new obligation, and the original term. The step-down annual obligation may represent the straight-line annual accrual cost for a step-down lease specifying terms in line with the base rent, the original square footage, the rent escalator, the original term, the step-down term, and the step-down space reduction factor. In an embodiment, the step-down annual obligation may be calculated using Equation [4] discussed with respect to FIG. 2A.

At 470, the step-down annual obligation may be subtracted from the original annual accrual cost to identify an annual accrual reduction, for example as shown in Equation [5] discussed with respect to FIG. 2A. The step-down annual obligation may represent the cost savings (e.g., straight-line accounting benefits) of the step-down lease compared to a traditional fixed term, fixed space lease.

Finally, at 480, a step-down lease may be generated based on the step-down annual obligation when the annual accrual reduction exceeds a reduction threshold. The reduction threshold may represent an amount of reduction from the original annual accrual cost. For example, the lessee may set the reduction threshold at 25%, which may then be compared to the resulting annual obligation reduction determined at 470. In an embodiment, the reduction threshold may be determined based on expense requirements received from the lessee. In an embodiment, the lessor may additionally or alternatively set a reduction limit that represents a reduction value not to be exceeded by the annual obligation reduction.

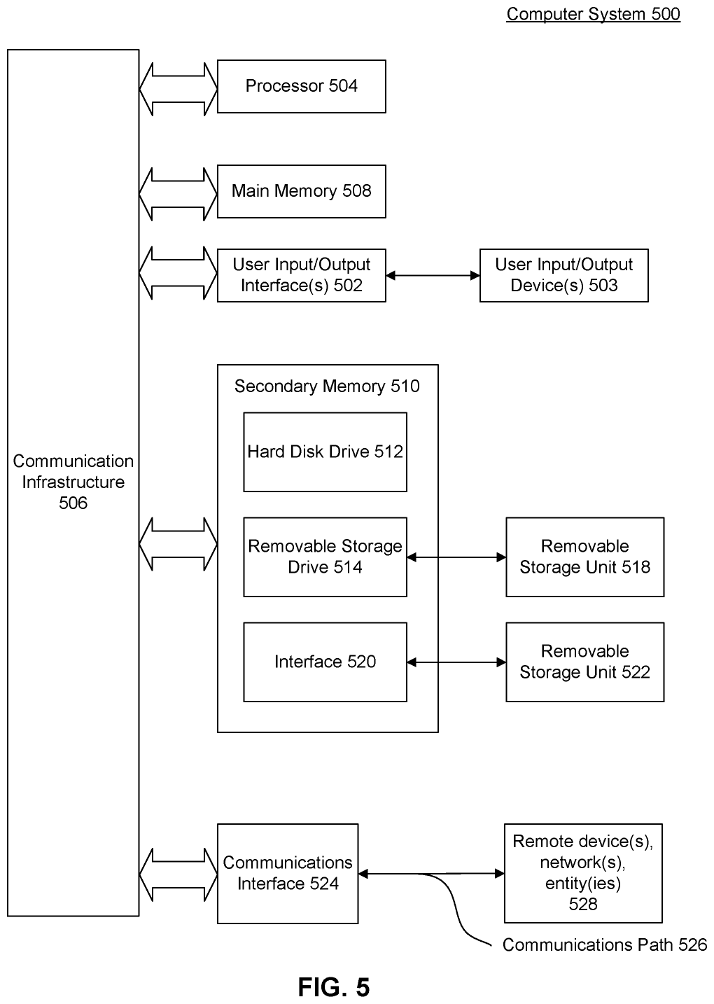

Various embodiments can be implemented, for example, using one or more computer systems, such as computer system 500 shown in FIG. 5. Computer system 500 can be used, for example, to implement the step-down engine 310 of FIG. 3 and/or the process 400 of FIG. 4, and/or any of the structure and functionality depicted in FIGS. 1-4. Computer system 500 can be any computer capable of performing the functions described herein.

Computer system 500 can be any well-known computer capable of performing the functions described herein.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a server device connected to a packet-switched network;
a connection manager, implemented on the server device, configured to:
receive, via the packet-switched network, a base rent, an original square footage, a rent escalator, and an original term;
a step-down core, implemented on the server device, configured to:
determine a step-down term and a step-down space reduction factor;
compute an original annual accrual cost based on the base rent, the original square footage, the rent escalator, and the original term;
compute a remaining accrual obligation based on the original annual accrual cost and an initial term, wherein the initial term represents a difference between the original term and the step-down term;
determine a new obligation based on the base rent, the rent escalator, the step-down term, and a reduced square footage, wherein the reduced square footage is calculated from the original square footage and the step-down space reduction factor;
calculate a step-down annual obligation based on the remaining accrual obligation, the new obligation, and the original term; and
subtract the step-down annual obligation from the original annual accrual cost to identify an annual obligation reduction; and
a reporting manager, implemented on the server device, configured to:
generate a step-down lease based on step-down annual obligation when the annual obligation reduction exceeds a reduction threshold.

2. The system of claim 1, wherein to determine the step-down term and the step-down space reduction factor the step-down core is further configured to:
receive, via the connection manager, the step-down term and the step-down space reduction factor from a lessee.

3. The system of claim 1, wherein to determine the step-down term and the step-down space reduction factor the step-down core is further configured to:
receive, via the connection manager, a personnel count and an estimated growth rate from a lessee; and
automatically estimate the step-down space reduction factor based on the personnel count and the estimated growth rate.

4. The system of claim 3, further comprising:
a query manager, implemented on the server device, configured to:
retrieve historical lessee space usage from a data repository,
wherein to estimate the step-down space reduction factor the step-down core is further configured to:
identify an industry associated with the lessee;
correlate the industry to the historical lessee space usage; and
automatically estimate the step-down space reduction factor based on the correlated historical lessee space usage.

5. The system of claim 1, wherein the connection manager is further configured to receive the reduction threshold from a lessee.

6. The system of claim 1, wherein the reduction threshold is determined based on expense requirements received from a lessee.

7. The system of claim 1, wherein the original annual accrual cost is computed on a straight-line basis over a duration of the original term.

8. The system of claim 1, wherein the step-down lease enables a lessor to terminate the step-down lease after the initial term.

9. The system of claim 1, wherein the step-down lease includes a space reduction, and wherein the step-down lease enables a lessee to decline the space reduction after the initial term.

10. The system of claim 1, wherein the connection manager is further configured to receive the base rent, the original square footage, the rent escalator, and the original term via a network interface coupled to the packet-switched network.

11. A method, comprising:
receiving a base rent, an original square footage, a rent escalator, and an original term;
determining a step-down term and a step-down space reduction factor;
computing an original annual accrual cost based on the base rent, the original square footage, the rent escalator, and the original term;
computing a remaining accrual obligation based on the original annual accrual cost and an initial term, wherein the initial term represents a difference between the original term and the step-down term;
determining a new obligation based on the base rent, the rent escalator, the step-down term, and a reduced square footage, wherein the reduced square footage is calculated from the original square footage and the step-down space reduction factor;
calculating a step-down annual obligation based on the remaining accrual obligation, the new obligation, and the original term;
subtracting the step-down annual obligation from the original annual accrual cost to identify an annual obligation reduction; and
generating a step-down lease based on step-down annual obligation when the annual obligation reduction exceeds a reduction threshold.

12. The method of claim 11, wherein determining the step-down term and the step-down space reduction factor further comprises:
receiving the step-down term and the step-down space reduction factor from a lessee.

13. The method of claim 11, wherein determining the step-down term and the step-down space reduction factor further comprises:
receiving a personnel count and an estimated growth rate from a lessee; and
automatically estimating the step-down space reduction factor based on the personnel count and the estimated growth rate;

14. The method of claim 13, wherein the estimating further comprises:
identifying an industry associated with the lessee;
correlating the industry to historical lessee space usage; and
automatically estimating the step-down space reduction factor based on the historical lessee space usage.

15. The method of claim 11, further comprising receiving the reduction threshold from a lessee.

16. The method of claim 11, wherein the reduction threshold is determined based on expense requirements received from a lessee.

17. The method of claim 11, wherein the original annual accrual cost is computed on a straight-line basis over a duration of the original term.

18. The method of claim 11, wherein the step-down lease enables a lessor to terminate the step-down lease after the initial term.

19. The method of claim 11, wherein the step-down lease includes a space reduction, and wherein the step-down lease enables a lessee to decline the space reduction after the initial term.

20. The method of claim 11, further comprising reducing the original annual accrual cost based on a concession received from a lessor.
